(19) United States
(12) Patent Application Publication
(10) Pub. No.: US 2024/0106530 A1
(43) Pub. Date: Mar. 28, 2024

(54) METHOD FOR SATELLITE SELECTION

(71) Applicant: ZTE Corporation, Shenzhen (CN)

(72) Inventors: Zhijun Li, Shenzhen (CN); Jinguo Zhu, Shenzhen (CN)

(73) Assignee: ZTE Corporation, Shenzhen (CN)

(21) Appl. No.: 18/521,545

(22) Filed: Nov. 28, 2023

Related U.S. Application Data
(63) Continuation of application No. PCT/CN2021/109631, filed on Jul. 30, 2021.

(51) Int. Cl. H04B 7/185; H04B 7/195; H04W 48/20

(52) U.S. Cl. CPC H04B 7/18558; H04B 7/195; H04W 48/20; H04W 84/06

(57) ABSTRACT

A wireless communication method for use in a wireless terminal is disclosed. The method comprises receiving, from a wireless network node, a satellite selection policy, and applying the satellite selection policy on a satellite selection.

### CROSS-REFERENCE TO RELATED APPLICATIONS

This application is a continuation of PCT/CN2021/109631, filed on Jul. 30, 2021, titled “METHOD FOR SATELLITE SELECTION”, and published as WO 2023/004757 A1, the entirety of which is incorporated herein by reference.

### TECHNICAL FIELD

This document is directed generally to wireless communications, in particular to satellite discovery and selection for wireless communications.

### BACKGROUND

The integration of satellite network and terrestrial network is a new trend in satellite communications. The effective use of cellular networks, their functional entities, signaling procedures and interfaces in the satellite networks is an important part of non-terrestrial network (NTN) development. It is conducive to the effective integration and unified management of satellite networks and terrestrial networks.

In an area where there is no terrestrial network coverage, a user equipment (UE) may find suitable satellites to setup satellite connection and thus access the terrestrial network (e.g. 5G network) via the satellite connection. According to an altitude of each satellite, the satellites can be classified into different satellite types, e.g., geostationary equatorial orbit (GEO) satellite, medium Earth orbit (MEO) satellite and low Earth orbit (LEO) satellite. Each type of satellite provides differentiated coverage and quality of service (QoS). For example, in comparison with the GEO satellite and the MEO satellite, the LEO satellite may provide the smallest coverage but provide the QoS with the highest bitrates and the least latency. The GEO satellite may provide the largest coverage but provide the QoS with the lowest bitrates and the largest latency when comparing to the MEO satellite and the LEO satellite. Among the three types of satellite, the MEO satellite may provide a moderate coverage and a moderate QoS.

Different types of satellite may be suitable for different types of data services. Thus, how to select the appropriate type of satellite for accessing the network is an important topic needing to be discussed.

### SUMMARY

This document relates to methods, systems, and devices for satellite discovery and selection, in particular to methods, systems, and devices for satellite discovery and selection at UE side.

The present disclosure relates to a wireless communication method for use in a wireless terminal. The method comprises:
receiving, from a wireless network node, a satellite selection policy, and
applying the satellite selection policy on a satellite selection.

Various embodiments may preferably implement the following features:

Preferably, the satellite selection policy comprises at least one satellite group.

Preferably, each of the at least one satellite group is associated with one of: a preferred satellite group, an allowed satellite group, or a forbidden satellite group.

Preferably, each of the at least one satellite group is associated with at least one satellite type.

Preferably, the at least one satellite type comprises a geostationary orbit, a medium Earth orbit, a low earth orbit or other satellite type.

Preferably, each of the at least one satellite group is associated with a policy scope of applying the satellite selection policy.

Preferably, the policy scope is associated with at least one of a network slice, a data network, a protocol data unit session, an application, a service or a traffic flow.

Preferably, applying the satellite selection policy on the satellite selection comprises at least one of:

applying the satellite selection policy on the satellite selection for accessing a network slice,
applying the satellite selection policy on the satellite selection for establishing a protocol data unit session, or
applying the satellite selection policy on the satellite selection for one of an application, a service or a traffic flow.

The present disclosure relates to a wireless communication method for use in a policy control function. The method comprises transmitting, to a wireless terminal, a satellite selection policy associated with a satellite selection.

Various embodiments may preferably implement the following features:

Preferably, the satellite selection policy comprises at least one satellite group.

Preferably, each of the at least one satellite group is associated with one of: a preferred satellite group, an allowed satellite group, or a forbidden satellite group.

Preferably, each of the at least one satellite group is associated with at least one satellite type.

Preferably, the at least one satellite type comprises a geostationary orbit, a medium Earth orbit, a low earth orbit or other satellite type.

Preferably, each of the at least one satellite group is associated with a policy scope of applying the satellite selection policy.

Preferably, the policy scope is associated with at least one of a network slice, a data network, a protocol data unit session, an application, a service or a traffic flow. Preferably, the satellite selection policy is comprised in a session management policy or a user equipment policy.

Preferably, the satellite selection policy is determined based on at least one of:
user subscription information of the wireless terminal,
a wireless terminal capability,
a radio access technology associated with the wireless terminal, or
a local policy associated with an enablement of the wireless terminal to apply the satellite selection policy on the satellite selection.

The present disclosure relates to a wireless terminal. The wireless terminal comprises:
a communication unit, configured to receive, from a wireless network node, a satellite selection policy, and
a processor configured to apply the satellite selection policy on a satellite selection.

Various embodiments may preferably implement the following feature:

Preferably, the processor is further configured to perform any of aforementioned wireless communication methods.

The present disclosure relates to a wireless device comprising a policy control function. The wireless device comprises:
a communication unit, configured to transmit, to a wireless terminal, a satellite selection policy associated with a satellite selection.

Various embodiments may preferably implement the following features:

Preferably, the wireless device further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a transparent satellite access network architecture according to an embodiment of the present disclosure.

FIG. 2 shows a schematic diagram of a procedure of requesting PDU service from the 5G network via the satellite access according to an embodiment of the present disclosure.

FIG. 3 shows a schematic diagram of a registration procedure according to an embodiment of the present disclosure.

FIG. 4 shows a schematic diagram of a procedure according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 shows a flowchart of a method according to an embodiment of the present disclosure.

FIG. 8 shows a flowchart of a method according to an embodiment of the present disclosure.

### DETAILED DESCRIPTION

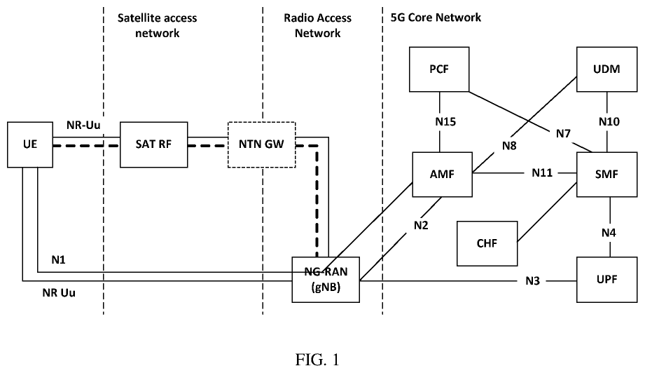

FIG. 1 shows a schematic diagram of a transparent satellite access network architecture according to an embodiment of the present disclosure. In FIG. 1, the satellite acts as an analogue radio frequency repeater and provides a transparent tunnel between the UE and a radio access network (RAN) node (e.g. gNB). In general, the satellite repeats an NR-Uu radio interface from a feeder link (between the NTN gateway and the satellite) to a service link (between the satellite and the UE) and vice versa.

Specifically, the network architecture shown in FIG. 1 comprises the following network entities or network functions:
1) UE (User Equipment): The UE corresponds to a mobile terminal accessing to the (5G) network, either directly via the RAN node (e.g. next generation RAN node (NG-RAN), gNB) or via a satellite.
2) SAT RF (Satellite Radio Function): The satellite payload implements frequency conversion and a radio frequency amplifier in both uplink and downlink directions.
3) NTN GW (Non-Terrestrial Network Gateway): The NTN GW supports all necessary functions to forward signals of the NR-Uu interface. Normally, the NTN GW is deployed on the ground, and one NTN GW may be configured to serve a list of gNBs.
4) NG RAN (Next Generation Radio Access Network): In the 5G network, the NG RAN is a new radio (NR) base station, i.e. gNB.
5) AMF (Access and Mobility Management function): The AMF provides access management and mobility management, such as registration to network, registration during UE mobility, etc., for the UE.
6) SMF (Session Management Function): The SMF provides PDU session management, e.g. IP address allocation, QoS flow setup, etc., for the UE.
7) UPF (User plane function): The UPF provides internet protocol (IP) traffic routing and forwarding management.
8) PCF (Policy Control Function): The PCF provides QoS policy rules to control plane functions, to enforce the QoS policy rules.
9) CHF (Charging Function): The CHF collects charging reports from other network function, e.g. the SMF. The CHF belongs to a charging system.
10) UDM (Unified Data Management): The UDM manages data for access authorization, user registration, and data network profiles.

In the network of an operator, one or more NTN GW(s) may be deployed for the satellite access. The NTN GW is normally deployed on the ground and configured to connect one or more gNB s, to serve multiple satellites.

When there is no terrestrial network coverage, the UE may find suitable satellite(s) to setup satellite connection(s), so as to access 5G network through the satellite connection and to get services (e.g. protocol data unit (PDU) service) from the 5G network.

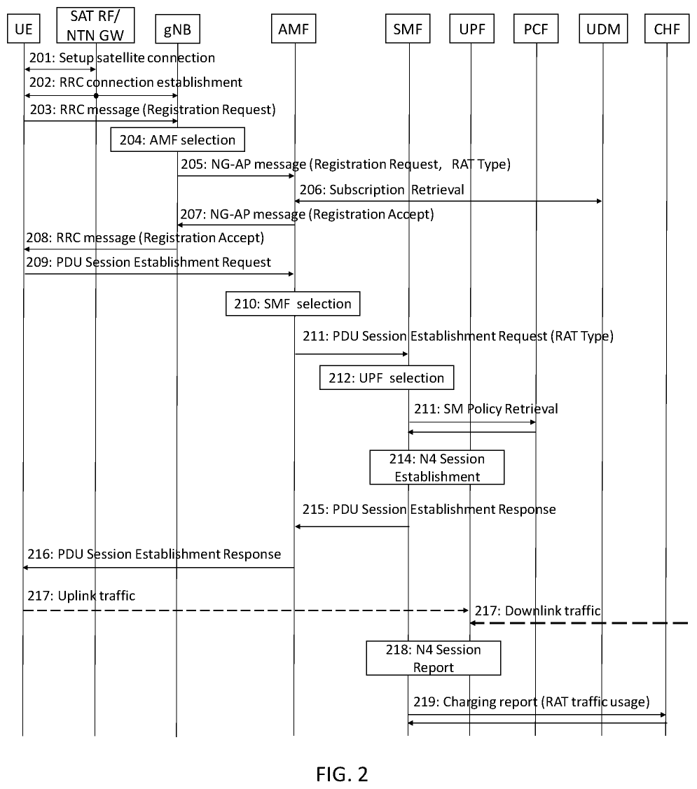

FIG. 2 shows a schematic diagram of a procedure of requesting PDU service from the 5G network via the satellite access according to an embodiment of the present disclosure.

Step 201: The UE sets up a connection with a satellite. When the UE moves to an area without terrestrial network coverage, it may decide to access the (5G) network via the satellite. Thus, the UE searches available satellites and selects suitable satellite(s) to setup the satellite connection(s).

Step 202: The UE sets up a radio resource control (RRC) connection towards the gNB.

When receiving a message (e.g. RRC message) from the UE on top of a satellite connection, the satellite transparently forwards the message to the connected NTN GW, and the NTN GW transparently forwards the message to a proper gNB. The NTN GW may use the Satellite Cell Identifier (ID) associated with the satellite to decide which gNB to forward the RRC message.

Step 203: The UE sends a Registration Request which is encapsulated in an RRC message towards the gNB. The RRC message is transparently forwarded by the satellite and the NTN GW and finally reaches the gNB.

Step 204: The gNB selects an appropriate AMF for the UE.

Step 205: The gNB forwards the Registration Request to the selected AMF.

The Registration Request is encapsulated in an NG application protocol (NG-AP) message. The gNB indicates the following information in the NG-AP message: the Global RAN Node ID of the NG-RAN, the Satellite Cell ID, etc. The AMF determines the radio access technology (RAT) type as the Satellite RAT, e.g. based on the Global RAN Node ID of the NG-RAN.

Step 206: The AMF retrieves UE subscription information from the UDM, to determine whether the Registration Request can be accepted.

Step 207: If the Registration Request is accepted, the AMF returns a Registration Accept message which is encapsulated in an NG-AP message towards the gNB.

Step 208: The gNB forwards the Registration Accept message to the UE.

Step 209: The UE sends a PDU Session Establishment Request to the AMF. Necessary parameters such as data network name (DNN) and Single Network Slice Selection Assistance Information (S-NSSAI) are included in the request message.

Step 210: The AMF selects a proper SMF based on the necessary parameters such as the DNN and the S-NSSAI. The RAT Type (e.g. Satellite RAT) and Cell ID (e.g. Satellite Cell ID) may also be used for selecting the SMF.

Step 211: The AMF sends a PDU Session Establishment Request to the SMF. Parameters such as the DNN, the S-NSSAI, the RAT Type, the Cell ID are included in the request message, if available.

Step 212: The SMF selects a proper UPF for the PDU session.

Step 213: The SMF retrieves a session management (SM) policy from the PCF. The RAT Type (e.g. Satellite RAT) and Cell ID (e.g. Satellite Cell ID) may be used as input parameters for retrieving the SM policy.

Step 214: The SMF establishes an N4 session with the selected UPF.

Step 215: The SMF sends a PDU Session Establishment Response to the AMF, if the PDU session establishment is successful.

Step 216: The AMF sends the PDU Session Establishment Response to the UE. The PDU Session Establishment Response message encapsulated in an NG-AP message is sent to the gNB and forwarded by the gNB to the UE encapsulated in an RRC message.

Step 217: After the PDU session is successfully established, the UPF thus can forward uplink traffics from the UE to a remote server and/or forward downlink traffics from the remote server to the UE. When forwarding the traffics, the UPF counts the traffic usage from/to the UE.

Step 218: If needed, the UPF initiates N4 session report procedure to send traffic usage report to the SMF.

Step 219: The SMF generates charging report based on the traffic usage report from the UPF and sends the charging report to the CHF. The RAT Type (e.g. Satellite RAT) is included in the message, so as to allow the charging system to perform RAT specific charging rules.

In FIG. 2, the RAT Type indicating the Satellite RAT is provided to the PCF to generate the SM policy, e.g. to determine a QoS configuration of the PDU session. However, the SM policy does not give clear instructions on whether the PDU session requires special satellite accesses. Furthermore, the procedure shown in FIG. 2 cannot prevent the UE from selecting incorrect satellite type during a mobility scenario, since there is no instruction given to the UE to indicate that which satellite type is required to support the QoS requirements of the PDU session.

Most of data services have certain requirements on QoS guaranty and UE mobility restriction, which may restrict the types of satellite suitable for the data services. For example, the GEO/MEO satellite may not fulfill the requirements of a service which requires higher bitrates. That is, the UE may need to select suitable satellite type based on the data services.

In addition, when accessing the 5G network via the satellite access, the UE needs to select a proper network slice. The network slice implicitly indicates certain service(s). In other words, the network slice may also require an appropriate satellite.

Furthermore, when requesting the PDU session via the satellite access, the UE needs to provide the correct DNN and network slice. The DNN may be associated with its corresponding services. Thus, the PDU session may also require the satellite access of the appropriate satellite type.

To support such requirements, the 5G network shall be able to instruct the UE to select the correct satellite type and/or to prevent the UE from using an incorrect satellite type for the application/service/PDU session/network slice.

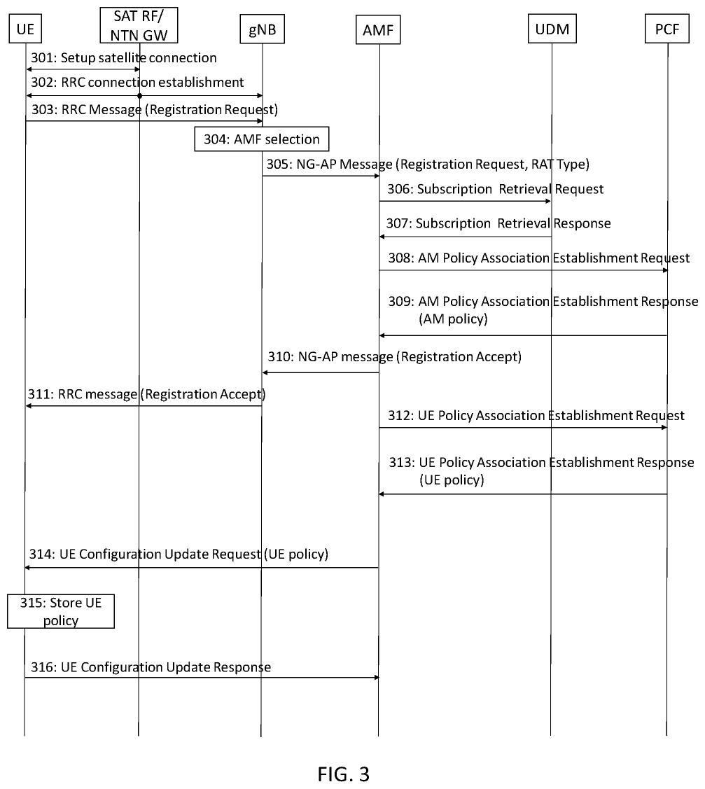

FIG. 3 shows a schematic diagram of a registration procedure according to an embodiment of the present disclosure. In FIG. 3, the PCF provides a UE policy to the AMF during the registration procedure, wherein the UE policy includes a Satellite Discovery & Selection Policy (SDSP) and the SDSP is transmitted to the UE. The UE therefore can apply the SDSP on the satellite selection. Specifically, the registration procedure comprises the following steps:

Step 301: The UE sets up a satellite connection.

Step 302: The UE sets up an RRC connection towards a gNB via the NTN GW.

Step 303: The UE sends a Registration Request which is encapsulated in an RRC message towards the gNB via the NTN GW.

Within the Registration Request, the UE may indicate its satellite communication capability to the AMF.

Step 304: The gNB selects an appropriate AMF for the UE.

Step 305: The gNB forwards the Registration Request to the selected AMF.

In step 305, the gNB may provide the Satellite RAT Type (i.e. GEO, MEO, LEO and/or other satellite type) to the AMF. In an embodiment, the GEO, MEO, LEO and other satellite type may be expressed as NR(GEO), NR(MEO), NR(LEO) and NR(OTHERSAT) in the Satellite RAT Type. As an alternative, the gNB may provide a satellite specific Global RAN Node ID to the AMF. Based on the satellite specific Global RAN Node ID, the AMF can determine the Satellite RAT Type.

Step 306: The AMF sends a Subscription Retrieval Request to the UDM, to fetch UE subscription information.

Step 307: The UDM sends a Subscription Retrieval Response to the AMF, carrying the UE subscription information. According to the UE subscription information, the AMF can determine whether the Registration Request can be accepted.

Step 308: The AMF sends an access and mobility management policy (AM policy) Association Establishment Request to the PCF, to fetch an AM policy.

Step 309: The PCF sends an AM Policy Association Establishment Response to the AMF, carrying the AM policy.

Step 310: If the Registration Request is accepted, the AMF returns a Registration Accept message which is encapsulated in an NG-AP message towards the gNB.

Step 311: The gNB forwards the Registration Accept message to the UE.

Step 312: The AMF sends a UE Policy Association Establishment Request to the PCF, to fetch the UE policy. The UE Policy Association Establishment Request provides parameters associated with acquiring the UE policy, e.g. the RAT Type. In this procedure, the RAT Type indicates the Satellite RAT Type. In addition, the UE capability of supporting the satellite communication may also be provided in the UE Policy Association Establishment Request.

Step 313: The PCF sends a UE Policy Association Establishment Response to the AMF, carrying the UE policy. For example, the PCF may trigger a UE Configuration Update procedure to delivery UE policy towards the UE.

Note that the PCF may further make decision to apply the SDSP to the UE, if such policy is configured to this UE. In this embodiment, the PCF may include the SDSP in the UE policy returned to the AMF.

When determining to provide the SDSP to the UE, the PCF may consider at least one of the following factors: (a) local policy to enable/disable the feature, (b) user subscription information of the UE, (c) the UE capability of supporting satellite communication, (d) whether the reported RAT Type indicates Satellite RAT Type, etc.

In an embodiment, the SDSP includes at least one Satellite Policy Group and the associated Satellite Policy Scope.

Each Satellite Policy Group indicates one of the following groups:
Preferred Satellite Types, indicating the satellite types which are preferred to be used in the associated usage scope;
Allowed Satellite Types, indicating the satellite types which are allowed to be used in the associated usage scope;
Not Allowed Satellite Types, indicating the satellite types which are not allowed to the associated usage scope.

The Satellite Policy Scope is associated to one Satellite Policy Group for indicating at least one of the following scopes:
applied to an indicated network slice, which is identified by the S-NSSAI;
applied to an indicated data network, which is identified by the DNN;
applied to an indicated PDU session, identified by the DNN or by the DNN and S-NSSAI;
applied to an indicated application/service, which is identified by the application/service descriptor;
applied to an indicated traffic flow, which is identified by the traffic flow descriptor.

Step 314: The AMF sends a UE Configuration Update Command towards the UE, carrying the UE Policy container. The SDSP is included in the UE Policy container.

Step 315: The UE stores the SDSP in its local configuration.

Step 316: If the UE Configuration Update Command requires, the UE sends a UE Configuration Update complete message to the AMF.

In an embodiment, the SDSP may need to be updated when the subscription of the UE (e.g. user subscription information) varies. Under such a condition, the PCF may have to transmit the updated SDSP to the UE. For example, the PCF may transmit, to the AMF, the updated SDSP. The AMF then transmits the updated SDSP to the UE, e.g., via a UE Configuration Update procedure.

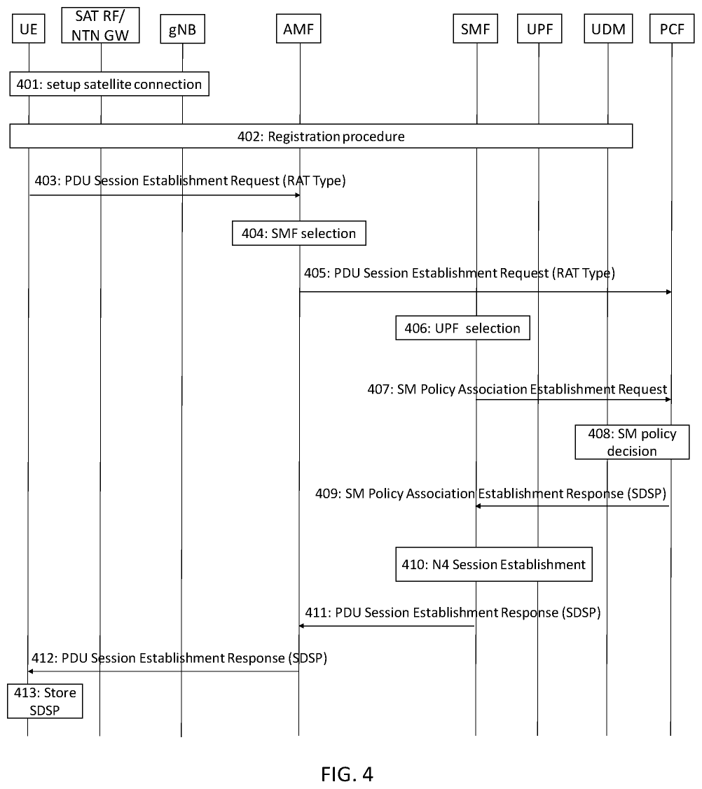

FIG. 4 shows a schematic diagram of a procedure according to an embodiment of the present disclosure. In FIG. 4, the PCF provides the SM policy to the SMF, e.g. during a PDU Session Establishment procedure. The SDSP is included in the SM policy and is transmitted to the UE. Based on the SDSP, the UE becomes able to select the appropriate satellite type for the satellite access of the specific network slice/data network/application/service/PDU session.

In detail, the procedure shown in FIG. 4 comprises the following steps:

Step 401: The UE sets up a connection with a satellite.

Step 402: The UE performs a Registration procedure towards the AMF.

In an embodiment, during the Registration procedure, the gNB may provide the Satellite RAT Type (i.e. NR(GEO), NR(MEO), NR(LEO) or NR(OTHERSAT) to the AMF. Alternatively, the gNB may provide a satellite specific Global RAN Node ID to the AMF. According to the satellite specific Global RAN Node ID, the AMF can determine the Satellite RAT Type.

Step 403: The UE sends a PDU Session Establishment Request to the AMF. In an embodiment, the PDU Session Establishment Request comprises at least one of the DNN and the S-NSSAI.

Step 404: The AMF selects a proper SMF based on, e.g., the DNN and/or the S-NSSAI. In an embodiment, the RAT Type (e.g. NR(GEO)/NR(MEO)/NR(LEO)/NR(OTHERSAT)) and/or Cell ID (e.g. Satellite Cell ID) may also be used for selecting the SMF.

Step 405: The AMF sends a PDU Session Establishment Request to the SMF. Within the message, at least one of the following necessary parameters may be included: the DNN, the S-NSSAI, the Satellite RAT Type. In addition, the UE capability of supporting the satellite communication may also be provided.

Step 406: The SMF selects a proper UPF for the PDU session.

Step 407: The SMF sends a SM policy Association Establishment Request to the PCF. In an embodiment, the SM policy Association Establishment Request comprises the DNN and/or the S-NSSAI and/or the Satellite RAT Type. In addition, the satellite communication capability of the UE may also be provided in this message.

Step 408: The PCF determines the SM policy based on the input parameters, such as the DNN and/or the S-NSSAI and/or the RAT Type.

In an embodiment, the PCF may further make decision on whether to apply the SDSP to this UE, if such policy is configured to this UE. If yes, the PCF includes the SDSP in the SM policy returned to the SMF.

The PCF takes other factors into account to make the decision, as described in the registration procedure shown in FIG. 3. The detailed contents of the SDSP are also similar to those of the SDSP in the registration procedure shown in FIG. 3.

Step 409: The PCF sends an SM policy Association Establishment Response to the SMF. The SMF gets the SDSP from the SM policy Association Establishment Response message.

Step 410: The SMF establishes an N4 session with the selected UPF.

Step 411: The SMF sends a PDU Session Establishment Response to the AMF, if the PDU session establishment is successful. The SDSP is included in this message.

Step 412: The AMF sends a PDU Session Establishment Response to the UE. The SDSP is included in this message.

Step 413: The UE stores the SDSP in its local configuration.

In an embodiment, the PCF may provide the SDSP to the SMF in the PDU session establishment procedure and/or in the PDU session modification procedure. In such cases, the SMF sends the PDU session modification response to the UE, wherein the response message carries the SDSP.

By adopting the above procedures, the PCF pushes the SDSP to the UE. The UE therefore can use the SDSP to guide the satellite selection.

Based on the SDSP, the UE may perform at least one of:
If the Preferred Satellite Type(s) is provided and applied to an indicated network slice/data network/PDU session/application/traffic flow, the UE should select the indicated satellite type, if possible, to serve the indicated network slice/data network/PDU session/application/traffic flow;
If the Allowed Satellite Type(s) is provided and applied to an indicated network slice/data network/PDU session/application/traffic flow, the indicated satellite type can be selected to serve the indicated network slice/data network/PDU session/application/traffic flow;
If Not Allowed Satellite Type(s) is provided and applied to an indicated network slice/data network/PDU session/application/traffic flow, the indicated satellite type shall not be selected to serve the indicated network slice/data network/PDU session/application/traffic flow.

In an embodiment, the SDSP may be used by the UE in the following scenarios: (a) selecting a satellite to access an indicated network slice, (b) selecting a satellite to establish a PDU session to an indicated data network, (c) selecting a target satellite during mobility if a specific PDU session is established, (d) selecting a target satellite during mobility if a specific application is running, (e) selecting a target satellite during mobility if a specific traffic flow is on-going, etc.

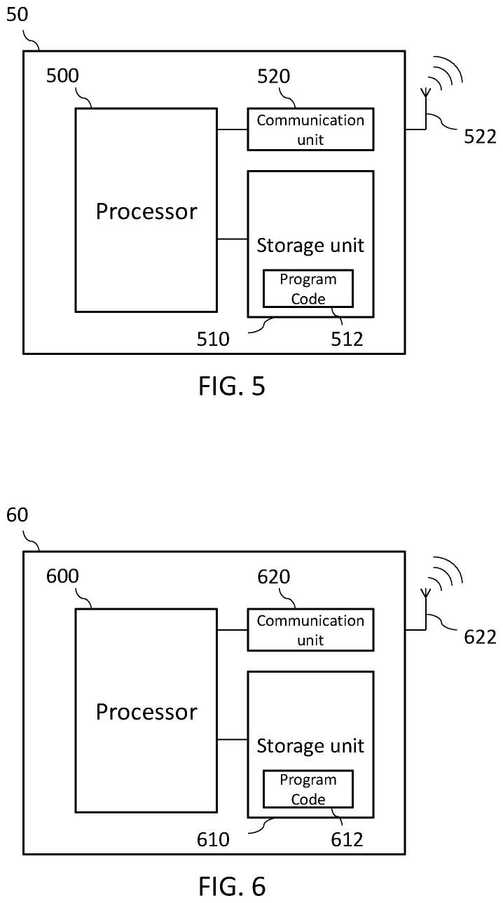

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g. messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g. a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet data network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g. messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g. a user equipment or another wireless network node).

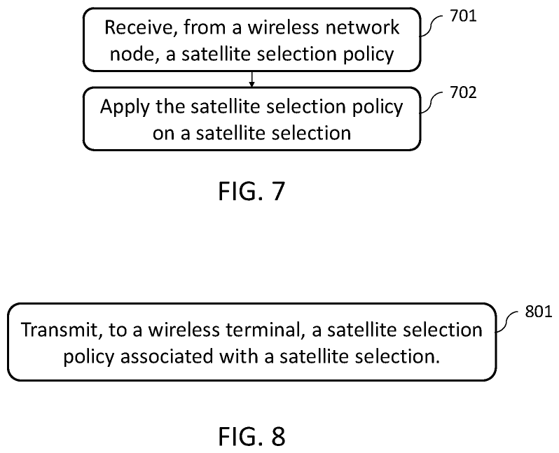

FIG. 7 shows a flowchart of a method according to an embodiment of the present disclosure. The method may be used in a wireless terminal (e.g. UE) and comprises the following steps:

Step 701: Receive, from a wireless network node, a satellite selection policy.

Step 702: Apply the satellite selection policy on a satellite selection.

In FIG. 7, the wireless terminal receives a satellite selection policy (e.g. SDSP) from a wireless network node (e.g. AMF, SMF, PCF, a wireless device comprising/performing the functionalities of at least one of the AMF SMF, PCF). The wireless terminal applies the received satellite selection policy on a satellite selection, e.g., to select an appropriate satellite (type) for subsequent data transmissions (e.g. PDU session, network slice, data network, application, service, traffic flow).

In an embodiment, the satellite selection policy comprises at least one satellite group.

In an embodiment, each of the at least one satellite group is associated with (e.g. comprises, includes) a policy scope of applying the satellite selection policy. For example, the policy scope is associated with at least one of a network slice, a data network, a PDU session, an application, a service or a traffic flow.

In an embodiment, each of the at least one satellite group is associated with (e.g. comprises, includes) one of: a preferred satellite group, an allowed satellite group, or a forbidden (e.g. not-allowed) satellite group.

In an embodiment, each of the at least one satellite group is associated with (e.g. comprises, includes) at least one satellite type. For instance, the at least one satellite type comprises a GEO, a MEO, a LEO or other satellite type.

In an embodiment, each of the at least one satellite group is associated with (e.g. comprises, includes) one of a preferred satellite group, an allowed satellite group, or a forbidden (e.g. not-allowed) satellite group for a policy scope. In this embodiment, each of the at least one satellite group may indicate the satellite type(s) (e.g. at least one of the GEO, MEO, LEO, other satellite type) allowed/preferred/forbidden to be used for the associated policy scope.

In an embodiment, a first satellite group is associated with an allowed satellite group for a network slice. The first satellite group indicates the satellite type(s) allowed to be used/selected for the specific network slice.

In an embodiment, a second satellite group is associated with a preferred satellite group for a PDU session. In this embodiment, the second satellite group indicate the satellite type(s) preferred to be used/selected for the specific PDU session.

In an embodiment, a third satellite group is associated with a forbidden satellite group for an application and/or a service (type). In other words, the third satellite group indicates the satellite type(s) which should be prevented from using/selecting for the specific application and/or service.

In an embodiment, the wireless terminal applies the satellite selection policy on the satellite selection for accessing a network slice.

In an embodiment, the wireless terminal applies the satellite selection policy on the satellite selection for establishing a PDU session.

In an embodiment, the wireless terminal applies the satellite selection policy on the satellite selection for one of an application, a service or a traffic flow.

In an embodiment, the wireless terminal receives the satellite selection policy in an SM policy (e.g. FIG. 4) and/or a UE policy (e.g. FIG. 3).

FIG. 8 shows a flowchart of a method according to an embodiment of the present disclosure. The method shown in FIG. 8 may be used in a PCF (e.g. a wireless device comprising the PCF or performing the functionalities of the PCF) and comprises the following step:

Step 801: Transmit, to a wireless terminal, a satellite selection policy associated with a satellite selection.

In FIG. 8, the PCF transmits a satellite selection policy (e.g. SDSP) to a wireless terminal (e.g. UE). The PCF may transmit the satellite selection policy to the wireless terminal via an SMF, an AMF, and/or an RAN node. The satellite selection policy may be associated with (e.g. used for, applied on) a satellite selection. Based on the satellite selection policy, the wireless terminal is able to select an appropriate satellite (type) for subsequent data transmissions (e.g. PDU session, network slice, data network, application, service, traffic flow).

In an embodiment, the satellite selection policy comprises at least one satellite group.

In an embodiment, each of the at least one satellite group is associated with (e.g. comprises, includes) a policy scope of applying the satellite selection policy. For example, the policy scope is associated with at least one of a network slice, a data network, a PDU session, an application, a service or a traffic flow.

In an embodiment, each of the at least one satellite group is associated with (e.g. comprises, includes) one of: a preferred satellite group, an allowed satellite group, or a forbidden (e.g. not-allowed) satellite group.

In an embodiment, each of the at least one satellite group is associated with (e.g. comprises, includes) at least one satellite type. For instance, the at least one satellite type comprises a GEO, a MEO, a LEO or other satellite type.

In an embodiment, each of the at least one satellite group is associated with (e.g. comprises, includes) one of a preferred satellite group, an allowed satellite group, or a forbidden (e.g. not-allowed) satellite group for a policy scope. In this embodiment, each of the at least one satellite group (or satellite selection policy) may indicate the satellite type(s) (e.g. at least one of the GEO, MEO, LEO, other satellite type) allowed/preferred/forbidden to be used for the associated policy scope.

In an embodiment, a first satellite group is associated with an allowed satellite group for a network slice. The first satellite group (or the satellite selection policy comprising the first satellite group) indicates the satellite type(s) allowed to be used for one specific network slice.

In an embodiment, a second satellite group is associated with a preferred satellite group for a PDU session. In this embodiment, the second satellite group (or the satellite selection policy comprising the second satellite group) indicates the satellite type(s) preferred to be used for the specific PDU session.

In an embodiment, a third satellite group is associated with a forbidden satellite group for an application and/or a service (type). In other words, the third satellite group (or the satellite selection policy comprising the third satellite group) indicates the satellite type(s) which should be prevented from using for the specific application/service.

In an embodiment, the satellite selection policy is applied on the satellite selection for accessing a network slice.

In an embodiment, the satellite selection policy is applied on the satellite selection for establishing a PDU session.

In an embodiment, the satellite selection policy is applied on the satellite selection for one of an application, a service or a traffic flow.

In an embodiment, the satellite selection policy is comprised in an SM policy (e.g. FIG. 4) or a UE policy (e.g. FIG. 3).

In an embodiment, the PCF determines the satellite policy of the wireless terminal based on at least one of:
user subscription information of the wireless terminal,
a wireless terminal capability (e.g. UE capability),
a radio access technology associated with the wireless terminal, or
a local policy associated with an enablement of the wireless terminal to apply the satellite selection policy on the satellite selection.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a satellite selection policy, and
applying the satellite selection policy on a satellite selection.

2. The wireless communication method of claim 1, wherein the satellite selection policy comprises at least one satellite group.

3. The wireless communication method of claim 2, wherein each of the at least one satellite group is associated with one of: a preferred satellite group, an allowed satellite group, or a forbidden satellite group.

4. The wireless communication method of claim 2, wherein each of the at least one satellite group is associated with at least one satellite type.

5. The wireless communication method of claim 4, wherein the at least one satellite type comprises a geostationary orbit, a medium Earth orbit, a low earth orbit or other satellite type.

6. The wireless communication method of claim 2, wherein each of the at least one satellite group is associated with a policy scope of applying the satellite selection policy.

7. The wireless communication method of claim 6, wherein the policy scope is associated with at least one of a network slice, a data network, a protocol data unit session, an application, a service or a traffic flow.

8. The wireless communication method of claim 1, wherein applying the satellite selection policy on the satellite selection comprises at least one of:
applying the satellite selection policy on the satellite selection for accessing a network slice,
applying the satellite selection policy on the satellite selection for establishing a protocol data unit session, or
applying the satellite selection policy on the satellite selection for one of an application, a service or a traffic flow.

9. A wireless communication method for use in a policy control function, the method comprising:
transmitting, to a wireless terminal, a satellite selection policy associated with a satellite selection.

10. The wireless communication method of claim 9, wherein the satellite selection policy comprises at least one satellite group.

11. The wireless communication method of claim 10, wherein each of the at least one satellite group is associated with one of: a preferred satellite group, an allowed satellite group, or a forbidden satellite group.

12. The wireless communication method of claim 10, wherein each of the at least one satellite group is associated with at least one satellite type.

13. The wireless communication method of claim 12, wherein the at least one satellite type comprises a geostationary orbit, a medium Earth orbit, a low earth orbit or a remaining satellite type.

14. The wireless communication method of claim 10, wherein each of the at least one satellite group is associated with a policy scope of applying the satellite selection policy.

15. The wireless communication method of claim 14, wherein the policy scope is associated with at least one of a network slice, a data network, a protocol data unit session, an application, a service or a traffic flow.

16. The wireless communication method of claim 9, wherein the satellite selection policy is comprised in a session management policy or a user equipment policy.

17. The wireless communication method of claim 9, wherein the satellite selection policy is determined based on at least one of:
user subscription information of the wireless terminal,
a wireless terminal capability,
a radio access technology associated with the wireless terminal, or
a local policy associated with an enablement of the wireless terminal to apply the satellite selection policy on the satellite selection.

18. A wireless terminal, comprising:
a communication unit, configured to receive, from a wireless network node, a satellite selection policy, and
a processor configured to apply the satellite selection policy on a satellite selection.
